(19) United States
(12) Patent Application Publication
(10) Pub. No.: US 2015/0052880 A1
(43) Pub. Date: Feb. 26, 2015

(54) INORGANIC FIBER PAPER

(71) Applicant: UNIFRAX I LLC, Tonawanda, NY (US)

(72) Inventor: Nicholas Vandervoort, Buffalo, NY (US)

(21) Appl. No.: 14/467,417

(22) Filed: Aug. 25, 2014

Related U.S. Application Data
(60) Provisional application No. 61/870,014, filed on Aug. 26, 2013.

(51) Int. Cl. F02B 77/11; F01N 3/021; F01N 3/02

(52) U.S. Cl. CPC F02B 77/11; F01N 3/0205; F01N 3/021
USPC 60/311; 252/62; 428/426; 428/433

(57) ABSTRACT

An inorganic fiber paper includes inorganic fibers, chopped glass fibers and a binder system containing both inorganic and organic binder components. The binder system contains a low content of the organic binder that imparts suitable handling properties and tensile strength to the inorganic fiber paper without causing the paper to emit a flame when used in demanding high temperature environments. The inorganic fiber paper can be used for a variety of automotive and industrial thermal insulation applications.

The present application claims the benefit of the filing date under 35 U.S.C. 119(e) from United States Provisional Application For Patent Ser. No. 61/870,014 filed on Aug. 26, 2013.

### TECHNICAL FIELD

This disclosure relates to a high temperature resistant inorganic fiber paper and insulation products incorporating the paper that are useful for a variety of high temperature thermal insulation applications.

### BACKGROUND

Inorganic fiber based insulation materials are used for high temperature environments normally encountered in various automotive applications. The inorganic fiber insulation material is typically processed into a paper that must possess suitable handling properties to permit the manufacture of commercial products incorporating the insulation material. That is, the inorganic fiber paper must be able to retain its structure and possess a certain level of flexibility.

Current manufacturing processes, such as those processes used to produce automotive heat shields, demand that the inorganic fiber based insulation materials possess a certain minimum tensile strength.

Organic binders have been used to improve flexibility and handling properties, and to impart tensile strength, to the inorganic fiber papers. However, commonly used organic binders have been found to emit a flame when used in demanding high temperature automotive environments. The evolution of an open flame from the inorganic fiber paper in the engine compartment in an automobile is a dangerous and undesired consequence of the inclusion of high levels of organic binders in insulation papers used in automotive applications.

What is still needed in the art are inorganic fiber based insulation materials for use in automotive and industrial thermal insulation that possesses good flexibility, good handling properties, tensile strength and flame resistance.

### DETAILED DESCRIPTION

The inorganic fiber paper comprises a plurality of inorganic fibers, a plurality of glass fibers that are different in chemical composition from said inorganic fibers, organic fiber reinforcement, and organic binder. The inorganic fiber insulation paper exhibits good flexibility, good handling properties, and good tensile strength. The inorganic fiber paper does not emit a flame when exposed to temperatures of 400° C. or greater. Therefore, the inorganic fiber paper exhibits flame resistance as the organic binder does not emit a flame upon the first heat cycle experienced during normal operation of a new automobile. The inorganic fiber paper also exhibits a tensile strength of 150 kPa or greater. According to illustrative embodiments, the tensile strength of the paper is 200 kPa or greater, or 300 kPa or greater, or 400 kPa or greater.

According to certain illustrative embodiments, inorganic fiber paper comprises a plurality of ceramic fibers; a plurality of glass fibers that are different in chemical composition from said ceramic fibers; organic binder fiber; and organic liquid binder.

According to certain illustrative embodiments, the inorganic fiber paper comprises a plurality of silica fibers, a plurality of chopped glass fibers that are different in chemical composition from said silica fibers, organic reinforcing binder fiber, and organic binder.

According to certain illustrative embodiments, the inorganic fiber paper comprises a plurality of silica fibers, a plurality of chopped S-glass fibers that are different in chemical composition from said silica fibers, organic reinforcing binder fiber, and organic binder.

According to certain embodiments, inorganic fiber paper comprises a plurality of biosoluble inorganic fibers, a plurality of chopped glass fibers that are different in chemical composition from said biosoluble fibers, organic reinforcing binder fiber, and organic binder.

According to certain illustrative embodiments, inorganic fiber paper comprises a plurality of biosoluble inorganic fibers, a plurality of chopped S-glass fibers that are different in chemical composition from said biosoluble fibers, organic reinforcing binder fiber, and organic binder.

Also disclosed is a heat shield for high temperature thermal insulation applications. The heat shield comprises at least one support layer and attached to the support layer at least one layer comprising a plurality of inorganic fibers, a plurality of chopped glass fibers that are different in chemical composition from said inorganic fibers, organic reinforcing fiber, and organic binder, wherein the paper has a tensile strength of at least 150 kPa and does not emit a flame when exposed to temperatures of 400° C. or greater.

According to certain embodiments, the heat shield comprises at least one support layer, and at least one inorganic fiber paper comprising a plurality of inorganic fibers, a plurality of chopped S-glass fibers, organic reinforcing binder fiber, and organic binder.

According to certain illustrative embodiments, the heat shield comprises at least one support layer, and at least one ceramic fiber paper comprising a plurality of ceramic fibers, a plurality of chopped glass fibers, organic reinforcing binder fiber, and organic binder.

According to certain illustrative embodiments, the heat shield comprises at least one support layer, and at least one ceramic fiber paper comprising a plurality of ceramic fibers, a plurality of chopped S-glass fibers, organic reinforcing binder fiber, and organic binder.

According to certain illustrative embodiments, the heat shield comprises at least one support layer and at least one silica fiber paper comprising a plurality of silica fibers, a plurality of glass fibers that are different in chemical composition from said inorganic fibers, organic reinforcing binder fiber, and organic binder.

According to certain illustrative embodiments, the heat shield comprises at least one support layer and at least one silica fiber paper comprising a plurality of silica fibers, a plurality of S-glass fibers that are different in chemical composition from said inorganic fibers, organic reinforcing binder fiber, and organic binder.

According to certain illustrative embodiments, the heat shield comprises at least one support layer and at least one biosoluble inorganic fiber paper comprising a plurality of biosoluble inorganic fibers, a plurality of chopped glass fibers that are different in chemical composition from said inorganic fibers, organic reinforcing binder fiber, and organic liquid binder.

According to certain illustrative embodiments, the heat shield comprises at least one support layer and at least one biosoluble inorganic fiber paper comprising a plurality of biosoluble inorganic fibers, a plurality of chopped S-glass fibers that are different in chemical composition from said inorganic fibers, organic reinforcing binder fiber, and organic liquid binder.

The heat shield may comprise first and second outer layers and at least one inner layer comprising a plurality of inorganic fibers, a plurality of chopped glass fibers that are different in chemical composition from said inorganic fibers, organic reinforcing binder fiber, and organic binder, wherein the paper has a tensile strength of at least 150 kPa and does not emit a flame when exposed to temperatures of 400° C. or greater.

The heat shield generally comprises first and second outer layers and at least one inner inorganic fiber insulation layer sandwiched between the first and second outer layers. The inner inorganic fiber insulation layer comprises an inorganic fiber paper including a plurality of inorganic fibers, a plurality of chopped glass fibers that are different in chemical composition from said inorganic fibers, organic reinforcing binder fiber, and organic binder. The construction of the first and second outer layers and the inner inorganic fiber insulation layer is a flexible sandwich structure.

According to certain illustrative embodiments, the heat shield comprises first and second outer layers and at least one inner ceramic fiber insulation layer sandwiched between the first and second outer layers. The inner ceramic fiber insulation layer comprises a ceramic fiber paper including a plurality of ceramic fibers, a plurality of chopped glass fibers that are different in chemical composition from said ceramic fibers, organic reinforcing binder fiber, and organic binder.

According to certain illustrative embodiments, the heat shield comprises first and second outer layers and at least one inner ceramic fiber insulation layer sandwiched between the first and second outer layers. The inner ceramic fiber insulation layer comprises a ceramic fiber paper including a plurality of ceramic fibers, a plurality of chopped S-glass fibers that are different in chemical composition from said ceramic fibers, organic reinforcing binder fiber, and organic binder.

According to further illustrative embodiments, the heat shield comprises first and second outer layers and at least one inner silica fiber insulation layer sandwiched between the first and second outer layers. The inner silica fiber insulation layer comprises a silica fiber paper including a plurality of silica fibers, a plurality of chopped glass fibers that are different in chemical composition from said silica fibers, organic reinforcing binder fiber, and organic binder.

According to further illustrative embodiments, the heat shield comprises first and second outer layers and at least one inner silica fiber insulation layer sandwiched between the first and second outer layers. The inner silica fiber insulation layer comprises a silica fiber paper including a plurality of silica fibers, a plurality of chopped S-glass fibers that are different in chemical composition from said silica fibers, organic reinforcing binder fiber, and organic binder.

According to further illustrative embodiments, the heat shield comprises first and second outer layers and at least one inner biosoluble inorganic fiber insulation layer sandwiched between the first and second outer layers. The inner biosoluble inorganic fiber insulation layer comprises a biosoluble inorganic fiber paper including a plurality of biosoluble inorganic fibers, a plurality of chopped glass fibers that are different in chemical composition from said inorganic fibers, organic reinforcing binder fiber, and organic binder.

According to further illustrative embodiments, the heat shield comprises first and second outer layers and at least one inner biosoluble inorganic fiber insulation layer sandwiched between the first and second outer layers. The inner biosoluble inorganic fiber insulation layer comprises a biosoluble inorganic fiber paper including a plurality of biosoluble inorganic fibers, a plurality of chopped S-glass fibers that are different in chemical composition from said inorganic fibers, organic reinforcing binder fiber, and organic binder.

The first and second outer layers of the heat shield may comprise a metal, a metal alloy, metal-matrix composite, metal alloy-matrix composite or combinations thereof. According to certain illustrative embodiments, the first and second outer layers of the heat shield sandwich structure comprise a layer or sheet of stainless steel.

Also provided is an automobile comprising an engine which generates exhaust gas, an exhaust gas system for expelling exhaust gas generated by the engine, and a heat shield comprising at least one support layer and at least one inorganic fiber paper comprising a plurality of inorganic fibers, a plurality of chopped glass fibers, organic binder fiber, and organic binder. The heat shield thermally insulates at least a portion of the system for expelling exhaust gases from the automobile.

According to certain embodiments, the automobile may comprise heat shields to protect the passenger cabin from heat passing through the exhaust gas system. Heat shields may be installed to, near, or adjacent an engine, an engine exhaust gas manifold, catalytic converter, diesel particulate filter, piping or muffler. Including a heat shield reduces heat loss from the automobile exhaust, and protects other automotive components and systems from thermal damage and degradation. As the heat shield reduces exhaust gas system heat loss, the engine compartment and engine intake manifold temperatures are reduced. A result of the reduced engine compartment temperature and engine intake manifold temperature is increased engine power and performance. Further, the heat shield maintains higher exhaust gas temperatures, improving engine performance by allowing the exhaust gases to flow more quickly through the exhaust gas system. An increased exhaust gas temperature leads to a more efficient catalytic reaction

According to certain illustrative embodiments, the automobile comprises an engine which generates exhaust gas, an exhaust gas system for expelling exhaust gas generated by the engine, and a heat shield comprising at least one support layer and at least one ceramic fiber paper comprising a plurality of ceramic fibers, a plurality of chopped glass fibers that are different in chemical composition from said ceramic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least one support layer and at least one ceramic fiber paper comprising a plurality of ceramic fibers, a plurality of chopped S-glass fibers that are different in chemical composition from said ceramic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least one support layer and at least one silica fiber paper comprising a plurality of silica fibers, a plurality of chopped glass fibers that are different in chemical composition from said silica fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least one support layer and at least one silica fiber paper comprising a plurality of silica fibers, a plurality of chopped S-glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least one support layer and at least one biosoluble inorganic fiber paper comprising a plurality of biosoluble inorganic fibers, a plurality of chopped glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least one support layer and at least one biosoluble inorganic fiber paper comprising a plurality of biosoluble inorganic fibers, a plurality of chopped S-glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising inorganic fibers, a plurality of chopped glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising inorganic fibers, a plurality of chopped S-glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner ceramic fiber insulation layer sandwiched between the first and second outer layers, the insulation layer comprising ceramic fibers, a plurality of chopped glass fibers that are different in chemical composition from said ceramic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner ceramic fiber insulation layer sandwiched between the first and second outer layers, the insulation layer comprising ceramic fibers, a plurality of chopped S-glass fibers that are different in chemical composition from said ceramic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising silica fibers, a plurality of chopped glass fibers that are different in chemical composition from said silica fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising silica fibers, a plurality of chopped S-glass fibers that are different in chemical composition from said silica fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising biosoluble inorganic fibers, a plurality of chopped glass fibers that are different in chemical composition from said inorganic fibers, organic reinforcing binder fiber, and organic binder.

According to certain illustrative embodiments, the automobile comprises an engine which generates exhaust gas, an exhaust gas system for expelling exhaust gas generated by the engine, and a heat shield comprising at least first and second outer layers and at least one inner inorganic fiber insulation layer sandwiched between the first and second outer layers, the insulation layer comprising biosoluble inorganic fibers, a plurality of chopped S-glass fibers that are different in chemical composition from said inorganic fibers, organic reinforcing binder fiber, and organic binder.

The inorganic fiber paper may comprise from about 90 to about 98.5 weight percent of said inorganic fibers, or from about 90 to about 98 weight percent of said inorganic fibers, or from about 90 to about 97.5 weight percent of said inorganic fibers.

The inorganic fiber paper may comprise from about 90 to about 98.5 weight percent of said ceramic fibers, or from about 90 to about 98 weight percent of said ceramic fibers, or from about 90 to about 97.5 weight percent of said ceramic fibers.

The inorganic fiber paper may comprise from about 90 to about 98.5 weight percent of said silica fibers, or from about 90 to about 98 weight percent of said silica fibers, or from about 90 to about 97.5 weight percent of said silica fibers.

The inorganic fiber paper may comprise from about 90 to about 98.5 weight percent of said biosoluble inorganic fibers, or from about 90 to about 98 weight percent of said biosoluble inorganic fibers, or from about 90 to about 97.5 weight percent of said biosoluble inorganic fibers.

The inorganic fiber paper may comprise from about 1 to about 10 weight percent of said plurality of glass fibers, or from about 1 to about 6 weight percent of said plurality of glass fibers, or from about 1 to about 5 weight percent of said plurality of glass fibers.

The inorganic fiber paper may comprise from about 1 to about 10 weight percent of said plurality of chopped glass fibers, or from about 1 to about 6 weight percent of said plurality of chopped glass fibers, or from about 1 to about 5 weight percent of said plurality of chopped glass fibers.

The inorganic fiber paper may comprise from about 1 to about 10 weight percent of said plurality of chopped S-glass fibers, or from about 1 to about 6 weight percent of said plurality of chopped S-glass fibers, or from about 1 to about 5 weight percent of said plurality of chopped S-glass fibers.

The inorganic fiber paper may comprise from about 0.1 to about 5 weight percent of said organic reinforcing fiber, or from about 0.25 to about 5 weight percent of said organic reinforcing fiber, or from about 0.25 to about 1 weight percent of said organic reinforcing fiber.

The inorganic fiber paper may comprise from about 0.25 to about 5 weight percent of said organic binder, or from about 0.5 to about 5 weight percent of said organic binder, or from about 0.5 to about 3.25 weight percent of said organic binder.

According to further illustrative embodiments, the inorganic fiber paper comprises from about 90 to about 97.5 weight percent of said inorganic fibers, from about 1 to about 6 weight percent of said plurality of glass fibers, from about 0.25 to about 1 weight percent of said organic reinforcing fiber, and from about 0.5 to about 3.25 weight percent of said organic binder.

According to further illustrative embodiments, the inorganic fiber paper comprises from about 90 to about 97.5 weight percent of said ceramic fibers, from about 1 to about 6 weight percent of said plurality of chopped S-glass fibers, from about 0.25 to about 1 weight percent of said polyvinyl alcohol organic reinforcing fiber, and from about 0.5 to about 3.25 weight percent of said acrylic latex binder.

According to further illustrative embodiments, the inorganic fiber paper comprises from about 90 to about 97.5 weight percent of said alumino-silicate ceramic fibers, from about 1 to about 6 weight percent of said plurality of chopped S-glass fibers, from about 0.25 to about 1 weight percent of said polyvinyl alcohol organic reinforcing fiber, and from about 0.5 to about 3.25 weight percent of said acrylic latex binder.

According to further illustrative embodiments, the inorganic fiber paper comprises from about 90 to about 97.5 weight percent of said alumino-silicate ceramic fibers, from about 1 to about 6 weight percent of said plurality of chopped S-glass fibers having an average length of about ½ inch, from about 0.25 to about 1 weight percent of said polyvinyl alcohol organic reinforcing fiber, and from about 0.5 to about 3.25 weight percent of said acrylic latex binder.

Any heat resistant inorganic fibers may be utilized as the inorganic fiber component in the inorganic fiber paper so long as the fibers can withstand the paper forming process, can form a paper with sufficient flexibility to incorporate the paper into other finished products (such as automotive heat shields) and can withstand the operating temperatures experienced in the environment in which the insulation paper is installed. Without limitation, suitable inorganic fibers that may be used to prepare the paper include high alumina polycrystalline fibers, refractory ceramic fibers such as alumino-silicate fibers, alumina-magnesia-silica fibers, kaolin fibers, biosoluble inorganic fibers such as alkaline earth silicate fibers, including calcia-magnesia-silica fibers and magnesia-silica fibers, calcia-alumina fibers, quartz fibers, silica fibers, and combinations thereof.

According to certain embodiments, the heat resistant inorganic fibers that are used to prepare the paper comprise ceramic fibers. Without limitation, suitable ceramic fibers include alumina fibers, alumina-silica fibers (also known as alumino-silicate), alumina-zirconia-silica fibers, zirconia-silica fibers, zirconia fibers, and similar fibers. A useful alumina-silica ceramic fiber is commercially available from Unifrax I LLC (Tonawanda, N.Y.) under the registered trademark FIBERFRAX®. The FIBERFRAX® ceramic fibers comprise the fiberization product of about 45 to about 75 weight percent alumina and about 25 to about 55 weight percent silica. The FIBERFRAX® fibers exhibit operating temperatures of up to about 1540° C. and a melting point up to about 1870° C. The FIBERFRAX® fibers easily formed into high temperature resistant sheets and papers.

According to certain embodiments, the alumina-silica fiber may comprise from about 40 weight percent to about 60 weight percent Al₂O₃ and about 60 weight percent to about 40 weight percent SiO₂. The fiber may comprise about 50 weight percent Al₂O₃ and about 50 weight percent SiO₂.

The alumina/silica/magnesia glass fiber typically comprises from about 64 weight percent to about 66 weight percent SiO₂, from about 24 weight percent to about 25 weight percent Al₂O₃, and from about 9 weight percent to about 10 weight percent MgO.

The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

The term “biosoluble” inorganic fibers refers to fibers that are decomposable in a physiological medium or in a simulated physiological medium such as simulated lung fluid. The solubility of the fibers may be evaluated by measuring the solubility of the fibers in a simulated physiological medium over time. A method for measuring the biosolubility (i.e.-the non-durability) of the fibers in physiological media is disclosed U.S. Pat. No. 5,874,375 assigned to Unifrax I LLC, although other methods are also suitable for evaluating the biosolubility of inorganic fibers. These fibers are also referred to in the art as non-durable fibers or low biopersistence fibers.

Without limitation, suitable examples of biosoluble inorganic fibers that can be used to prepare a insulation paper include those include biosoluble alkaline earth silicate fibers disclosed in U.S. Pat. Nos. 6,953,757, 6,030,910, 6,025,288, 5,874,375, 5,585,312, 5,332,699, 5,714,421, 7,259,118, 7,153,796, 6,861,381, 5,955,389, 5,928,075, 5,821,183, and 5,811,360, which are incorporated herein by reference.

According to certain embodiments, the biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the alkaline earth silicate fibers comprise the fiberization product of about 65 to about 86 weight percent silica, about 14 to about 35 weight percent magnesia and 5 weight percent or less impurities. According to other embodiments, the alkaline earth silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Tonawanda, New York) under the registered trademark ISOFRAX®. Commercially available ISOFRAX® fibers generally comprise the fiberization product of about 70 to about 80 weight percent silica, about 18 to about 27 weight percent magnesia, and 4 weight percent or less impurities.

According to certain embodiments, the biosoluble alkaline earth silicate fibers may comprise the fiberization product of a mixture of oxides of calcium, magnesium, and silica. These fibers are commonly referred to as calcia-magnesia-silica fibers. According to certain embodiments, the calcia-magnesia-silicate fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silicate fibers are commercially available from Unifrax I LLC (Tonawanda, N.Y.) under the registered trademark INSULFRAX®. INSULFRAX® fibers generally comprise the fiberization product of about 61 to about 67 weight percent silica, from about 27 to about 33 weight percent calcia, and from about 2 to about 7 weight percent magnesia. Other suitable calcia-magnesia-silicate fibers are commercially available from Thermal Ceramics (Augusta, Georgia) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia, and trace amounts of magnesia, alumina and iron oxide.

Suitable silica fibers use in the production of the insulation paper include those leached glass fibers available from BelChem Fiber Materials GmbH, Germany, under the trademark BELCOTEX®, from Hitco Carbon Composites, Inc. of Gardena Calif., under the registered trademark REFRASIL®, and from Polotsk-Steklovolokno, Republic of Belarus, under the designation PS-23(R).

The BELCOTEX® fibers are standard type, staple fiber pre-yarns. These fibers have an average fineness of about 550 tex and are generally made from silicic acid modified by alumina. The BELCOTEX® fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL® fibers, like the BELCOTEX® fibers, are amorphous leached glass fibers high in silica content for providing thermal insulation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23 (R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL® fibers, have a melting point of about 1700° C.

According to certain illustrative embodiments, the inorganic fiber paper comprises a non-woven matrix of ceramic fibers as the inorganic fiber component. The ceramic fibers may be any alumino-silicate refractory ceramic fibers known in the art suitable for high temperature resistant thermal insulation applications. Without limitation, and only by way of example, a suitable alumino-silicate refractory ceramic fiber is commercially available from Unifrax I LLC (Tonawanda, N.Y., USA) under the registered trademark FIBERFRAX®. The fibers may have an average length of about 50 to about 100 microns (about 0.002 to about 0.004 inch).

The binder system for the fiber paper may include both inorganic binder and organic binder components. The inorganic binder component of the binder system includes chopped glass fibers. The chopped glass fibers have a different chemical composition than the other inorganic fibers of the paper. According to certain embodiments, the chopped glass fibers comprise chopped S-glass fibers. The chopped S-glass fiber strands are longer than the other inorganic fiber strands contained in the paper, such as ceramic fiber strands, and are able to weave their way through the inorganic fiber matrix to hold the paper together. According to certain embodiments, the average length of chopped S-glass fibers is from about 0.1 inches to about 1.5 inches. According to certain embodiments, the average length of the chopped S-glass fibers is from about 0.25 inches to about 1.0 inches. According to certain embodiments, the average length of the chopped S-glass fibers is from about 0.4 to about 0.75 inches. According to certain embodiments, the average length of the chopped S-glass fibers is about ½ inch. The use of chopped S-glass fibers as a component of the paper binder system imparts strength to the paper and permits a paper to be produced by standard wet paper making processes without the need for the inclusion of large amounts of organic binder. The chopped S-glass strands also increase the tensile strength of the final paper product allowing it to be durable enough to survive the manufacturing environment. A suitable source of chopped S-glass is commercially available from AGY (Aiken, S.C., USA) under the trade designation 401 S-2 Glass.

The binder system also includes an organic binder component. At least a portion of the organic component of the binder system comprises organic reinforcing fibers. According to certain illustrative embodiments, the organic reinforcing fiber included in the binder system for the paper comprises polyvinyl alcohol (PVA) fibers. The inclusion of the PVA binder fibers at very low concentrations imparts strength to the paper with a low organic content. A suitable source of PVA fibers are the KURALON VPB105-2 grade PVA fibers commercially available from Kuraray (Japan). The VPB105-2 grade PVA fibers possess a cut length of about 4 mm, and exhibit a denier of 1.0, an average diameter of 11 microns, and are soluble in water at 60° C. Other reinforcing organic reinforcing fibers may include, but not be limited to, aromatic polyamide, such as aramid fibers or fibrids, such as KEVLAR® fibers or fibrids, NOMEX® fibers or fibrids, and polyacrylonitrile fibers or fibrids

The binder system includes another organic binder component different of the organic reinforcing fiber. The organic binder material may comprise an organic polymer latex. The latex is included in the binder system to improve flexibility, crack resistance, and overall handling properties of the paper and to decrease the dustiness of the product caused by the inclusion of the unfiberized particulate from the inorganic fibers. Without limitation, a suitable latex for inclusion in the binder system for the paper is HYCAR 26083 commercially available from Lubrizol Advanced Materials, Inc. (Cleveland, Ohio, USA). The HYCAR 26083 latex is a carboxylated acrylic copolymer latex. Other organic binders that may be used may include, but are not limited to, acrylic, styrene-butadiene, nitrile, polyvinylchloride, silicone, polyvinylacetate, or polyvinylbutyrate latexes.

Other components commonly used in the paper making process may be included in the production of the present paper. These additional processing components are not present in the resulting final paper product. These additional products may include a flocculent such as alum (aluminum sulfate), drainage retention aids, and dispersants. Flocculents are used to precipitate the organic latex binder onto the surface of the inorganic fibers. Drainage retention aids are used to pull the coated fibers together and allow any free water to be removed. Dispersants generally aid in the uniform mixing of the inorganic fibers. A suitable flocculent is a dialuminum trisulfate commercially available from Nalco (Naperville, Ill., USA) under the trade designation Nalco 7530.

The inorganic fiber paper may be produced in any way known in the art for forming sheet-like materials. For example, conventional paper-making processes, either hand laid or machine laid, may be used to prepare the inorganic fiber paper material. A handsheet mold, a Fourdrinier paper machine, or a rotoformer paper machine can be employed to make the paper.

For example, using a papermaking process, the inorganic fibers, chopped S-glass fibers, organic binder fiber, and liquid organic binder may be mixed together to form a mixture or slurry. The slurry of components may be flocculated by adding a flocculating agent to the slurry. The flocculated mixture or slurry is placed onto a papermaking machine to be formed into a ply or sheet of fiber containing paper. The sheet is dried by air drying or oven drying. For a more detailed description of standard papermaking techniques employed, see U.S. Pat. No. 3,458,329, the disclosure of which is incorporated herein by reference.

According to alternative embodiments, the plies or sheets of paper may be formed by vacuum casting the slurry. According to this method, the slurry of components is wet laid onto a pervious web. A vacuum is applied to the web to extract the majority of the moisture from the slurry, thereby forming a wet sheet. The wet plies or sheets are then dried, typically in an oven. The sheet may be passed through a set of rollers to compress the sheet prior to drying.

Regardless of which of the above-described techniques are employed, the fiber paper can be cut, such as by die stamping, to form papers of exact shapes and sizes with reproducible tolerances. The paper exhibits suitable handling properties meaning it can be easily handled and can sustain its paper shape without cracking or crumbling. The paper can be easily and flexibly fitted between two structures or wrapped around structured to be insulated from heat.

### EXPERIMENTAL

The following examples are set forth merely to further illustrate the inorganic fiber paper and the heat shield incorporating the inorganic fiber paper. The illustrative examples should not be construed as limiting the inorganic fiber paper, heat shield, devices incorporating the paper or heat shield, or the methods of making or using the paper or heat shield in any manner.

### Tensile Testing

The tensile testing of the inorganic fiber paper utilized 1 inch wide strips that were approximately 6 inches long. The test paper included the traditional “dog bone” shape at each end as is common with tensile testing. A template was made and the samples were cut out of sheets of material using a knife following the template to ensure each sample was the same size and prepared the same manner. The samples were held in place on an Instron machine using small pneumatic clamps. Once the clamps were closed the Instron machine slowly stretched the sample until the sample broke. The machine recorded the maximum force measured and this was determined to be the breaking point for the sample.

### Flame Testing

The flame testing was performed on an apparatus constructed from a ceramic substrate that had heating wires weaved through the outer layers of the substrate. This substrate was wrapped in a metal sheet that was tack welded on. Heat shields were formed using 2 specifically sized pieces of stainless steel foil and a section of the inventive inorganic fiber paper. The foil was placed on either side of the paper and the edges were folded over and crimped to create a part as similar to production as possible. The heat shields were formed around the heating apparatus and held tightly in place with a stainless steel hose clamp. The heating wires were connected to a controller that caused them to heat up and hold as desired. The control thermocouple was located on the shell of the heating apparatus opposite of where the heat shield was located and it was also held in place by the band clamp. The apparatus was heated to 700 ° C. in 5 minutes and then held there for 10 minutes. The apparatus was observed for any flame being emitted by the sample inorganic fiber paper at any point during the test.

Inorganic fiber papers were prepared from a slurry containing 93.5 weight percent FIBERFRAX® alumino-silicate ceramic fibers having a fiber index of 70, 2 weight percent HYCAR 26083 acrylic latex, 0.5 weight percent PVV fibers (KURALON VPB105-2 grade), 4 weight percent chopped S-glass fibers, alum, (NALCO 7530) and water. The inorganic fiber papers were evaluated for LOI, tensile strength, and flame generation.

Tables IA and IB below shows the LOI test results:

TABLE IA
LOI

| | | | | Mass Post | | |
|---|---|---|---|---|---|---|
| | Mass Pre Burn | | | Burn | | |
| Slit | | Crucible + | | Crucible + | Mass | |
| Location | Crucible | Sample | Sample | Sample | Loss | LOI |
| Outside | 113.525 | 137.148 | 23.623 | 136.641 | 0.507 | 2.15% |
| Middle | 134.692 | 157.98 | 23.288 | 157.596 | 0.384 | 1.65% |
| Inside | 113.52 | 137.656 | 24.136 | 137.256 | 0.5 | 1.66% |

TABLE IB
LOI

| Slit Location | Expected | Actual | Difference |
|---|---|---|---|
| Outside | 2.5% | 2.15% | −0.35% |
| Middle | 2.5% | 1.65% | −0.85% |
| Inside | 2.5% | 1.66% | −0.84% |

Table II below shows the tensile strength test results:

TABLE II
Tensile Strength (g/in)

| Slit | Sample | | | | | | |
|---|---|---|---|---|---|---|---|
| Location | 1 | 2 | 3 | 4 | 5 | Set | Sample |
| Outside | 1232 | 1507 | 1689 | 1471 | 1208 | 1208 | 1368 |
| Middle | 1337 | 1418 | 1220 | 1617 | 1145 | 1348 | |
| Inside | 1500 | 1493 | 1505 | 1014 | 1167 | 1336 | |

Table III below shows the flame test results:

TABLE III
FLAME TESTS

| Slit Location | Sample 1 | Sample 2 |
|---|---|---|
| Outside | NO | NO |
| Middle | NO | NO |
| Inside | NO | NO |

### Thermal Conductivity Testing

Thermal conductivity is a material property which indicates a material's ability to conduct heat through its body under a steady state condition. Thermal conductivity values may be obtained through laboratory testing, such as the set up described in ASTM C518 (2004) entitled “Standard Test Method for Steady-State Thermal Transmission Properties by Means of the Heat Flow Meter Apparatus”. ASTM C518 describes the testing procedure for the measurement of steady state thermal transmission through slab specimens using a heat flow meter apparatus.

According to ASTM C518, the test utilizes two isothermal plate assemblies (one hot, one cold), one or more heat flux transducers, equipment to control and measure temperatures, and samples with a given thickness. Three (3) test samples of 0.33 inch (0.84cm) thickness according to the presently claimed embodiments were tested according to ASTM C518 procedures. The test results are shown in Table IV below:

| | Test | Test Temp | Test Temp | Test Temp | K-Value | R-Value |
|---|---|---|---|---|---|---|
| Sample | Thickness | Hot Plate | Cold Plate | Mean | (BTU · in/hr · ft² · | (hr · ft² · |
| No. | (in/cm) | (° F./° C.) | (° F./° C.) | (° F./° C.) | ° F.)/(W/m-K) | ° F./BTU)/(W/m-K) |
| 1 | 0.33/0.84 | 95.0/35.0 | 55.0/12.8 | 75.0/23.9 | 0.238/0.0344 | 1.39 |
| 2 | 0.33/0.84 | 95.0/35.0 | 55.0/12.8 | 75.0/23.9 | 0.239/0.0344 | 1.38 |
| 3 | 0.33/0.84 | 95.0/35.0 | 55.0/12.8 | 75.0/23.9 | 0.239/0.0344 | 1.38 |

ASTM C518 requires that a material have a thermal conductivity below 0.2 W/m-K. Test samples 1, 2, and 3 all exhibited thermal conductivity values of 0.0344, which is below the standard requirement. Therefore, test samples prepared in accordance with the illustrative embodiments exhibit thermal conductivity levels below the ASTM C518 thermal conductivity test requirement and pass the standard.

### Material Flammability Testing

Material flammability concerns the rate at which a material combusts or burns. This test method is intended for measuring the burning rate of polymeric materials used in the operator and passenger compartments of vehicles. The applicable testing is described in SAE J369 entitled “Flammability of Polymeric Interior Materials—Horizontal Test Method”.

Five (5) ⅛ inch (0.32 cm) thick samples prepared according to the illustrative embodiments were tested according to SAE J369. The samples were held above a flame in a horizontal orientation. The test results are shown in Table V below:

| | After Flame Time | Flame Travel | Burn Rate |
|---|---|---|---|
| Test Specimen | (minutes:seconds) | (inches) | (inches/minute) |
| 1 | 0:00 | 0.00 | 0.00 |
| 2 | 0:00 | 0.00 | 0.00 |
| 3 | 0:00 | 0.00 | 0.00 |
| 4 | 0:00 | 0.00 | 0.00 |
| 5 | 0:00 | 0.00 | 0.00 |

SAE J369 requires that materials exhibit a burn rate of less than 4 inches per minute. Test samples 1, 2, 3, 4, and 5 all exhibited a burn rate of 0.00 inches per minute, and did not burn at all. Therefore, the test samples prepared in accordance with the illustrative embodiments meet the SAE J369 material flammability standards.

### Gas Flammability Testing

Gas flammability testing is a laboratory testing method to determine the combustion characteristics of materials. Samples are placed in an air atmosphere furnace and then heated to several hundred degrees Celsius to observe the fire hazard and fire risk of the sample materials. Gas flammability testing may be conducted in accordance with ASTM E316 entitled “Standard Test Method for Behavior of Materials in a Vertical Tube Furnace at 750° C”.

However, ASTM E316 requires that test samples be 2 inches (5.1 cm) in thickness. Samples of the inorganic fiber papers and heat shields according to the claimed embodiments about ⅛ inches (0.32cm) in thickness were tested. Therefore, the ASTM E316 standard was modified to reflect the operating conditions for exhaust gas treatment devices. For the purposes of testing the illustrative embodiments, samples only ⅛ inch (0.32 cm) thick by 1.5 inches (3.8 cm) long by 1.5 inches (3.8 cm) wide were utilized. Further, the test temperature was increased from 750° C. to 850° C., and the furnace air supply was turned off

The vertical tube furnace is heated to 850° C. A first thermocouple near the heated refractory records one set of readings, and then a second thermocouple placed in the volumetric center of the furnace records a second set of readings. When the set temperature of 850° C. is reached, the second thermocouple is replaced by the test sample which has two of its own thermocouples (third and fourth thermocouples in total). The third thermocouple measures temperature data on the surface of the test sample, and the fourth thermocouple measures temperature data from the volumetric center of the test sample.

Test samples are deemed to meet the ASTM E316 standard when three out of the four test specimens meet following conditions: 1) the temperature of the third and fourth thermocouples does not exceed the set point temperature established by the second thermocouple by more than 30° C.; 2) there is no flame emanating from the test specimen after 30 seconds; and 3) when the weight loss of the test specimen exceeds 50%, the recorded temperature of the third and fourth thermocouples do not rise above the furnace air temperature at the beginning of the test, and there is no flaming of the test specimen. Independent testing conducted on the illustrative embodiments confirmed that three of the four tested samples met the ASTM E316 required criteria.

While the inorganic fiber paper and heat shield have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the mounting mat and exhaust gas treatment device should not be limited to any single embodiment, but rather construed in breadth and scope in accordance with the recitation of the appended claims.

I claim:

1. An inorganic fiber paper comprising:
a plurality of inorganic fibers, a plurality of chopped glass fibers;
organic reinforcing fiber; and
organic binder,
wherein the paper has a tensile strength of at least 150 kPa and does not emit a flame when exposed to temperatures of 400° C. or greater.

2. The inorganic fiber paper of claim 1 comprising:
from about 90 to about 98.5 weight percent of said inorganic fibers;
from about 1 to about 10 weight percent of said plurality of glass fibers;
from about 0.1 to about 5 weight percent of said organic reinforcing fiber; and
from about 0.25 to about 5 weight percent of said organic binder.

3. The inorganic fiber paper of claim 2 comprising:
from about 90 to about 98 weight percent of said inorganic fibers;
from about 1 to about 6 weight percent of said plurality of glass fibers;
from about 0.25 to about 5 weight percent of said organic reinforcing fiber; and
from about 0.5 to about 5 weight percent of said organic binder.

4. The inorganic fiber paper of claim 3 comprising:
from about 90.5 to about 97.5 weight percent of said inorganic fibers;
from about 1 to about 6 weight percent of said plurality of glass fibers;
from about 0.25 to about 1 weight percent of said organic reinforcing fiber; and
from about 0.5 to about 3.25 weight percent of said organic binder.

5. The inorganic fiber paper of claim 1, wherein said inorganic fibers are selected from the group consisting of consisting of ceramic fibers, high alumina polycrystalline fibers, mullite fibers, biosoluble inorganic fibers, calcia-alumina fibers, quartz fibers, silica fibers, and combinations thereof

6. The inorganic fiber paper of claim 5, wherein the high alumina polycrystalline fibers comprise the fiberization product of about 72 to about 100 weight percent alumina and about 0 to about 28 weight percent silica.

7. The inorganic fiber paper of claim 5, wherein the ceramic fibers comprise alumino-silicate fibers comprising the fiberization product of about 45 to about 72 weight percent alumina and about 28 to about 55 weight percent silica.

8. The inorganic fiber paper of claim 5 wherein the biosoluble fibers comprise magnesia-silica fibers comprising the fiberization product of about 65 to about 86 weight percent silica, from about 14 to about 35 weight percent magnesia, and about 5 weight percent of less impurities.

9. The inorganic fiber paper of claim 5, wherein the magnesia-silica fibers comprise the fiberization product of about 70 to about 86 weight percent silica, about 14 to about 30 weight percent magnesia, and about 5 weight percent or less impurities.

10. The inorganic fiber paper of claim 9, wherein the magnesia-silica fibers comprise the fiberization product of about 70 to about 80 weight percent silica, about 18 to about 27 weight percent magnesia and 0 to 4 weight percent impurities.

11. The inorganic fiber paper of claim 5, wherein the biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

12. The inorganic fiber paper of claim 11, wherein the calcia-magnesia-silica fibers comprise the fiberization product of about 60 to about 70 weight percent silica, from about 16 to about 35 weight percent calcia, and from about 4 to about 19 weight percent magnesia.

13. The inorganic fiber paper of claim 12, wherein the calcia-magnesia-silica fibers comprise the fiberization product of about 61 to about 67 weight percent silica, from about 27 to about 33 weight percent calcia, and from about 2 to about 7 weight percent magnesia.

14. The inorganic fiber paper of claim 1, wherein the chopped glass fibers comprise chopped S-glass fibers.

15. The inorganic fiber paper of claim 14, wherein the length of the chopped S-glass fibers is about ½ inch.

16. The inorganic fiber paper of claim 1, wherein the organic reinforcing fibers comprise polyvinyl alcohol (PVA) fibers.

17. The inorganic fiber paper of claim 1, wherein the organic binder comprises an acrylic latex.

18. The inorganic fiber of claim 1, wherein the inorganic fibers comprises alumino-silicate ceramic fibers, wherein the chopped glass fibers comprise chopped S-glass fibers having a length of about ½ inch, wherein the organic reinforcing fibers comprise polyvinyl alcohol (PVA) fibers, and wherein the organic binder comprises an acrylic latex.

19. A heat shield comprising:
first and second outer layers; and
at least one inner layer comprising a plurality of inorganic fibers, a plurality of chopped glass fibers, organic reinforcing fiber, and organic binder,
wherein the paper has a tensile strength of at least 150 kPa and does not emit a flame when exposed to temperatures of 400° C. or greater.

20. The heat shield of claim 19 comprising:
from about 90 to about 98.5 weight percent of said inorganic fibers;
from about 1 to about 10 weight percent of said plurality of glass fibers;
from about 0.1 to about 5 weight percent of said organic reinforcing fiber; and
from about 0.25 to about 5 weight percent of said organic liquid binder.

21. The heat shield of claim 20 comprising:
from about 90 to about 98 weight percent of said inorganic fibers;
from about 1 to about 6 weight percent of said plurality of glass fibers;
from about 0.25 to about 5 weight percent of said organic reinforcing fiber; and
from about 0.5 to about 5 weight percent of said organic liquid binder.

22. The heat shield of claim 21 comprising:
from about 90.5 to about 97.5 weight percent of said inorganic fibers;
from about 1 to about 6 weight percent of said plurality of glass fibers;
from about 0.25 to about lweight percent of said organic reinforcing fiber; and
from about 0.5 to about 3.25 weight percent of said organic liquid binder.

23. The heat shield of claim 19, wherein said inorganic fibers are selected from the group consisting of consisting of ceramic fibers, high alumina polycrystalline fibers, mullite fibers, biosoluble inorganic fibers, calcia-alumina fibers, quartz fibers, silica fibers, and combinations thereof

24. The heat shield of claim 23, wherein the high alumina polycrystalline fibers comprise the fiberization product of about 72 to about 100 weight percent alumina, and about 0 to about 28 weight percent silica.

25. The heat shield of claim 24, wherein the ceramic fibers comprise alumino-silicate fibers comprising the fiberization product of about 45 to about 72 weight percent alumina, and about 28 to about 55 weight percent silica.

26. The heat shield of claim 23, wherein the biosoluble fibers comprise magnesia-silica fibers comprising the fiberization product of about 65 to about 86 weight percent silica, from about 14 to about 35 weight percent magnesia, and about 5 weight percent of less impurities.

27. The heat shield of claim 26, wherein the magnesia-silica fibers comprise the fiberization product of about 70 to about 86 weight percent silica, about 14 to about 30 weight percent magnesia, and about 5 weight percent or less impurities.

28. The heat shield of claim 27, wherein the magnesia-silica fibers comprise the fiberization product of about 70 to about 80 weight percent silica, about 18 to about 27 weight percent magnesia, and 0 to 4 weight percent impurities.

29. The heat shield of claim 23, wherein the biosoluble fibers comprise calcia-magnesia-silica fibers comprising the fiberization product of about 45 to about 90 weight percent silica, greater than 0 to about 45 weight percent calcia, and greater than 0 to about 35 weight percent magnesia.

30. The heat shield of claim 29, wherein the calcia-magnesia-silica fibers comprise the fiberization product of about 60 to about 70 weight percent silica, from about 16 to about 35 weight percent calcia, and from about 4 to about 19 weight percent magnesia.

31. The heat shield of claim 30, wherein the calcia-magnesia-silica fibers comprise the fiberization product of about 61 to about 67 weight percent silica, from about 27 to about 33 weight percent calcia, and from about 2 to about 7 weight percent magnesia.

32. The heat shield of claim 19, wherein the chopped glass fibers comprise chopped S-glass fibers.

33. The heat shield of claim 19, wherein the length of the chopped S-glass fibers is about ½ inch.

34. The heat shield of claim 19, wherein the organic reinforcing fibers comprise polyvinyl alcohol (PVA) fibers.

35. The heat shield of claim 19, wherein the organic binder comprises an acrylic latex.

36. The heat shield of claim 19, wherein the inorganic fibers comprises alumino-silicate ceramic fibers, wherein the chopped glass fibers comprise chopped S-glass fibers having a length of about ½ inch, wherein the organic reinforcing fibers comprise polyvinyl alcohol (PVA) fibers, and wherein the organic binder comprises an acrylic latex.

37. The heat shield of claim 19 wherein the first and second layers comprise a layer or sheet of metal, metal alloy, metal-matrix composite, metal alloy-matrix composite or combinations thereof

38. The heat shield of claim 37, wherein the metal alloy comprises stainless steel.

39. An automobile comprising:
an engine that generates exhaust gas;
an exhaust gas treatment device in communication with said engine for expelling generated exhaust gas from the automobile; and
the heat shield of claim 19, wherein the heat shield is installed to, near, or adjacent said engine or exhaust gas treatment device.
